(19) United States
(12) Patent Application Publication
(10) Pub. No.: US 2025/0354002 A1
(43) Pub. Date: Nov. 20, 2025

(54) PROPYLENE-BASED COPOLYMER COMPOSITON

(71) Applicant: Basell Poliolefine ltalia S.r.l., Milano (IT)

(72) Inventors: Francesca Tisi, Ferrara (IT); Riccardo Fioravanti, Ferrara (IT)

(73) Assignee: Basell Poliolefine ltalia S.r.l., Milano (IT)

(21) Appl. No.: 18/871,662

(22) PCT Filed: May 24, 2023
(86) PCT No.: PCT/EP2023/063963

§ 371 Date: Dec. 4, 2024

(30) Foreign Application Priority Data
Jun. 6, 2022 (EP) 22177392.2

(51) Int. Cl. C08L 23/16

(52) U.S. Cl. CPC C08L 23/16

(57) ABSTRACT

A polyolefin composition made from or containing:
A) from 72 wt % to 90 wt % of a copolymer of propylene with ethylene, having a content of ethylene derived units, measured by NMR, between 3.3 wt % and 6.0 wt %;
B) from 9 wt % to 28 wt % of a propylene ethylene copolymer, having a content of ethylene derived units, measured by NMR, from 3.6 wt % to 7.5 wt %;
wherein the polyolefin composition, having a content of ethylene derived units measured by NMR, between 3.5 wt % and 5.5 wt %;
the sum of the amounts A+B being 100; and
C) from 10000 ppm to 100 ppm of talc, having a particle size distribution, measured with SediGraph 5100 particle size analysis system, between 0.5 and 5 um; and a specific surface area B.E.T. (ISO 9277:2010) higher than 15 m²/g;
ppm being calculated on the sum of the amounts of A+B.

### FIELD OF THE INVENTION

In general, the present disclosure relates to the field of chemistry. More specifically, the present disclosure relates to polymer chemistry. In particular, the present disclosure relates to a composition made from or containing propylene ethylene copolymers and ultrafine talc.

### BACKGROUND OF THE INVENTION

In some instances, different applications use tailored polymers, thereby achieving the individual demanding properties. For instance, a polymer used for injection molding has other properties as a polymer used for blow molding.

In some instance, the extrusion blow molding process allows for the preparation of different kinds of bottles with respect to size and shape. In some instances, the solidification step of the extrusion blow molding process is more complex than in an injection molding process.

In some instances, extrusion blown molded articles show poorer optical properties compared to injection molded articles. In some instances, the surface property inside or outside of extrusion blown bottles is non-uniform (having flow lines or melt fracture), thereby leading to lower overall gloss and transparency as compared to injection-molded bottles or injection-stretched, blow-molded, bottles.

### SUMMARY OF THE INVENTION

In a general embodiment, the present disclosure provides a polyolefin composition made from or containing:

A) from 72 wt % to 90 wt % of a copolymer of propylene with ethylene, having:
i) a content of ethylene derived units, measured by NMR, between 3.3 wt % and 6.0 wt %, based upon the total weight of the copolymer (A);
(ii) a melting temperature, measured by DSC, ranging from 132° C. to 143° C.;
(iii) a melt flow rate (230° C./5 kg., ISO 1133) ranging from 1.1 g/10 min to 3.5 g/10 min; and
(iv) xylene solubles at 25° C. ranging from 4.0 wt % to 10.0 wt %, based upon the total weight of the copolymer (A); and
   B) from 9 wt % to28 wt % of a propylene ethylene copolymer, having
i) a content of ethylene derived units, measured by NMR, ranging from 3.6 wt % to 7.5 wt %, based upon the total weight of the copolymer (B); and
ii) a melt flow rate (230° C./5 kg., ISO 1133) ranging from 0.6 g/10 min to 10 g/10 min; wherein the polyolefin composition, having
i) a content of ethylene derived units, measured by NMR, between 3.5 wt % and 5.5 wt %, based upon the total weight of the polyolefin composition;
ii) a content of ethylene derived units, measured by NMR, in the fraction soluble in xylene at 25° between 15.2 wt % and 23.2 wt %, based upon the total weight of soluble fraction;
iii) a melt flow rate (ISO 1133 (230° C., 5 kg)) ranging from 1.0 g/10 min to 4.0 g/10 min;
iv) xylene solubles at 25° C. ranging from 5.1 wt % to 12.0 wt %, based upon the total weight of the polyolefin composition;
v) an intrinsic viscosity, measured in tetrahydronaphthalene at 135° C., of the fraction soluble in xylene at 25° C. ranging from 0.6 dl/g to 2.5 dl/g; and
vi) the difference between the ethylene derived units content of component B and the ethylene derived units content of component A (C2B-C2A) ranging from 0.3 to 4.0 wt %;
the sum of the amounts A+B being 100; and
   C) from 10000 ppm (1.0 wt %) to 100 ppm (0.01 wt %) of talc, having
i) a particle size distribution, measured with SediGraph 5100 particle size analysis system, between 0.5 and 5 μm; and
ii) a specific surface area B.E.T. (ISO 9277:2010) higher than 15 m²/g; wherein ppm being calculated on the sum of the amounts of A+B.

### DETAILED DESCRIPTION OF THE INVENTION

In some embodiments, the present disclosure provides a polyolefin composition made from or containing:

A) from 72 wt % to 90 wt %; alternatively from 73 wt % to 88 wt %; alternatively from 74 wt % to 86 wt %; of a copolymer of propylene with ethylene, having:
i) a content of ethylene derived units between 3.3 wt % and 6.0 wt %; alternatively between 3.5 wt % and 5.5 wt %; alternatively between 3.7 wt % and 4.8 wt %, based upon the total weight of the copolymer (A);
(ii) a melting temperature ranging from 132° C. to 143° C.; alternatively from 134° C. to 142° C.; alternatively from 136° C. to 141° C.;
(iii) a melt flow rate (230° C./5 kg., ISO 1133) ranging from 1.1 g/10 min to 3.5 g/10 min; alternatively from 1.2 g/10 min to 2.5 g/10 min; alternatively from 1.3 g/10 min to 2.0 g/10 min; and
(iv) xylene solubles at 25° C. ranging from 4.0 wt % to 10.0 wt %; alternatively from 4.5 wt % to 9.0 wt %; alternatively from 5.2 wt % to 8.0 wt %, based upon the total weight of the copolymer (A); and
   B) from 9 wt % to 28 wt %; alternatively from 13 wt % to 27 wt %; alternatively from 14 wt % to 26 wt %, of a propylene ethylene copolymer, having
i) a content of ethylene derived units ranging from 3.6 wt % to 7.5 wt %; alternatively from 3.8 wt % to 7.0 wt %; alternatively from 4.0 wt % to 6.8 wt %, based upon the total weight of the copolymer (B); and
ii) a melt flow rate (230° C./5 kg., ISO 1133) ranging from 0.6 g/10 min to 10 g/10 min; wherein the polyolefin composition, having:
i) a content of ethylene derived units between 3.5 wt % and 5.5 wt %; alternatively between 3.8 wt % and 5.3 wt %; alternatively between 3.9 wt % and 5.0 wt %, based upon the total weight of the polyolefin composition;
ii) a content of ethylene derived units in the fraction soluble in xylene at 25° between 15.2 wt % and 23.2 wt %; alternatively between 16.3 wt % and 22.2 wt %; alternatively between 17.2 wt % and 21.3 wt %, based upon the total weight of soluble fraction;
iii) a melt flow rate (ISO 1133 (230° C., 5 kg)) ranging from 1.0 g/10 min to 4.0 g/10 min; alternatively from 1.1 g/10 min to 2.9 g/10 min; alternatively from 1.2 g/10 min to 2.5 g/10 min;
iv) xylene solubles at 25° C. ranging from 5.1 wt % to 12.0 wt %; alternatively from 5.5 wt % to 11.0 wt %; alternatively from 6.0 wt % to 10.0 wt %, based upon the total weight of the polyolefin composition;
v) an intrinsic viscosity of the fraction soluble in xylene at 25° C. ranging from 0.6 dl/g to 2.5 dl/g; alternatively from 0.8 dl/g to 2.0 dl/g; alternatively from 1.0 dl/g to 1.8 dl/g; and
vi) the difference between the ethylene derived units content of component B and the ethylene derived units content of component A (C2B-C2A) ranging from 0.3 to 4.0 wt %; alternatively from 0.4 to 3.5 wt %; alternatively from 0.4 and 3.0 wt %;
the sum of the amount of A+B being 100; and
   C) from 10000 ppm (1.0 wt %) to 100 ppm (0.01 wt %); alternatively from 8000 ppm (0.8 wt %) to 300 ppm (0.03 wt %); alternatively from 4000 ppm (0.4 wt %) to 500 ppm (0.05 wt %); of talc; having
i) a particle size distribution, measured with SediGraph 5100 particle size analysis system, between 0.5 and 5 μm; and
ii) a specific surface area B.E.T. (ISO 9277:2010) higher than 15 m²/g; alternatively ranging from 15 m²/g to 25 m²/g; alternatively from 16 m²/g to 23 m²/g; alternatively from 17 m²/g to 21 m²/g; wherein ppm being calculated on the sum of the amounts of A+B.

As used herein, the term “copolymer” refers to a bipolymer containing two monomers, propylene and ethylene.

In some embodiments, the present disclosure provides a process for blow molding objects made from or containing the polyolefin composition. In some embodiments, the objects are bottles. In some embodiments, the objects are sterilized, medical articles. In some embodiments, the process further includes the sterilization step of heating the polymer at 121° C. for 30 minutes.

In some embodiments, the polyolefin composition has one or more of the following features:

i) the difference between the haze measured before and after the sterilization (delta haze) ranging from 0.1 to 8.0, wherein the haze being measured on 1 mm plaque;
ii) a flexural modulus (ASTM D 790) ranging from 600 MPa to 950 MPa; alternatively from 670 MPa to 920 MPa; alternatively from 700 MPa to 900 MPa;
iii) a Charpy impact strength at 23° C. ranging from 20.0 kj/m² to 45.0 kj/m²; alternatively from 23.0 kj/m² to 40.0 kj/m²; alternatively from 25.0 kj/m² to 35.0 kj/m²; or
iv) the talc component C) having a surface area B.E.T. ranging from 15 m²/g to 20 m²/g, alternatively from 17 m²/g to 19 m²/g.

In some embodiments, the blow-molded objects are small blow molded articles, alternatively bottles, alternatively medical bottles, alternatively sterilized, medical bottles with minimal loss of optical properties. It is believed that component C) minimizes the haze after sterilization of the polyolefin composition.

In some embodiments, the present disclosure provides a bottle made from or containing the polyolefin composition. In some embodiments, the bottle is a sterilized bottle.

In some embodiments, the polyolefin composition is prepared by blending components A) and B).

In some embodiments, the polymerization of A) and B) is carried out in the presence of Ziegler-Natta catalysts. The catalysts are made from or containing a solid catalyst component made from or containing a titanium compound having a titanium-halogen bond and an electron-donor compound. The titanium compound and the electron-donor compound are supported on a magnesium halide in active form. The Ziegler-Natta catalysts are used with an organoaluminium compound as a cocatalyst. In some embodiments, the organoaluminum compound is an aluminum alkyl compound. An external donor is optionally added.

In some embodiments, the catalysts yield a polypropylene with a value of xylene insolubility at ambient temperature greater than 90%, alternatively greater than 95%.

In some embodiments, the catalysts are as described in U.S. Pat. No. 4,399,054 and European Patent No. 45977. In some embodiments, the catalysts are as described in U.S. Pat. No. 4,472,524.

In some embodiments, the solid catalyst components are made from or containing electron-donors (internal donors) are selected from the group consisting of ethers, ketones, lactones, compounds containing N, P and/or S atoms, and esters of mono-and dicarboxylic acids.

In some embodiments, the electron-donor compounds are esters of phthalic acid and 1,3-diethers of formula:

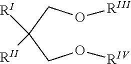

wherein R^{I} and R^{II} are the same or different and are C₁-C₁₈ alkyl, C₃-C₁₈ cycloalkyl, or C₇-C₁₈ aryl radicals; R^{III} and R^{IV} are the same or different and are C₁-C₄ alkyl radicals; or are the 1,3-diethers wherein the carbon atom in position 2 belongs to a cyclic or polycyclic structure made up of 5, 6, or 7 carbon atoms, or of 5-n or 6-n′ carbon atoms, and respectively n nitrogen atoms and n′ heteroatoms selected from the group consisting of N, O, S and Si, where n is 1 or 2 and n′ is 1, 2, or 3, the structure containing two or three unsaturations (cyclopolyenic structure), and optionally being condensed with other cyclic structures, or substituted with one or more substituents selected from the group consisting of linear or branched alkyl radicals; cycloalkyl, aryl, aralkyl, alkaryl radicals, and halogens, or being condensed with other cyclic structures and substituted with one or more of the above-mentioned substituents; one or more of the above-mentioned alkyl, cycloalkyl, aryl, aralkyl, or alkaryl radicals and the condensed cyclic structures optionally containing one or more heteroatom(s) as substitutes for carbon or hydrogen atoms, or both. In some embodiments, the substituents are bonded to the condensed cyclic structures.

In some embodiments, the ethers are selected from the ethers described in European Patent Application Nos. 361493 and 728769.

In some embodiments, the diethers are selected from the group consisting of 2-methyl-2-isopropyl-1,3-dimethoxypropane, 2,2-diisobutyl-1,3-dimethoxypropane, 2-isopropyl-2-cyclopentyl-1,3-dimethoxypropane, 2-isopropyl-2-isoamyl-1,3-dimethoxypropane, and 9,9-bis (methoxymethyl) fluorene.

In some embodiments, the electron-donor compounds are phthalic acid esters. In some embodiments, the phthalic acid esters are selected from the group consisting of diisobutyl phthalate, dioctyl phthalate, diphenyl phthalate, and benzylbutyl phthalate.

In some embodiments, a MgC₁₂·nROH adduct is reacted with an excess of TiCl4 containing the electron-donor compound. In some embodiments, the adduct is in the form of spheroidal particles. In some embodiments, n is from 1 to 3. In some embodiments, ROH is selected from the group consisting of ethanol, butanol, and isobutanol. In some embodiments, the reaction temperature is from 80 to 120° C. The solid is then isolated and reacted once more with TiC_{14,} in the presence or absence of the electron-donor compound, after which the reaction product is separated and washed with aliquots of a hydrocarbon until the chlorine ions have disappeared.

In some embodiments and in the solid catalyst component, the titanium compound, expressed as Ti, is present in an amount from 0.5 to 10% by weight. In some embodiments, the quantity of electron-donor compound, which remains fixed on the solid catalyst component, is 5 to 20% by moles with respect to the magnesium dihalide.

In some embodiments, the titanium compounds used for the preparation of the solid catalyst component are selected from the group consisting of halides of titanium and halogen alcoholates of titanium. In some embodiments, the titanium compound is titanium tetrachloride.

In some embodiments, the reactions form a magnesium halide in active form. In some embodiments, magnesium halide in active form results from reaction starting with magnesium compounds other than halides, such as magnesium carboxylates.

In some embodiments, the Al-alkyl compounds used as co-catalysts are made from or containing Al-trialkyls. In some embodiments, the Al-trialkyls are selected from the group consisting of Al-triethyl, Al-triisobutyl, Al-tri-n-butyl, and linear or cyclic Al-alkyl compounds containing two or more Al atoms bonded to each other by O or N atoms, or SO4 or SO3 groups.

In some embodiments, the Al-alkyl compound is used in a quantity such that the Al/Ti ratio is from 1 to 1000.

In some embodiments, the electron-donor compounds used as external donors are selected from the group consisting of aromatic acid esters and silicon compounds. In some embodiments, the aromatic acid esters are alkyl benzoates. In some embodiments, the silicon compounds contain a Si—OR bond, where R is a hydrocarbon radical.

In some embodiments, the silicon compounds are selected from the group consisting of (tert-butyl)2Si (OCH3)2, (cyclohexyl)(methyl)Si (OCH3)2, (cyclopentyl)2Si(OCH3)2, (phenyl)2Si (OCH3)2, and (1,1,2-trimethylpropyl)Si(OCH3)3.

In some embodiments, the internal donor is a 1,3-diether and the external donors are omitted.

In some embodiments, the component A) is prepared by using catalysts containing a phthalate, as internal donor, and (cyclopentyl) 2Si (OCH3)2, as outside donor. In some embodiments, the component A) is prepared by using catalysts containing 1,3-diethers as internal donors.

In some embodiments, the Ziegler-Natta catalyst is a solid catalyst component made from or containing a magnesium halide, a titanium compound having a Ti-halogen bond, and at least two electron donor compounds selected from succinates and the other being selected from 1,3 diethers.

In some embodiments, component B) is prepared by using the catalyst system or by using metallocene based catalyst system. In some embodiments, component B) is obtained by using gas phase polymerization processes, slurry polymerization processes, or solution polymerization processes.

In some embodiments, components (A) and (B) are prepared in a continuous sequential polymerization process, wherein component A) is prepared in a first reactor and component (B) is prepared in a second reactor in the presence of component A), operating in gas phase, in liquid phase in the presence or not of inert diluent, or by mixed liquid-gas techniques. The following examples are given for illustration without limiting purpose.

### EXAMPLE

### Characterization Methods

Melting temperature and crystallization temperature: Determined by differential scanning calorimetry (DSC)

A sample, weighing 6±1 mg, was heated to 220±1° C. at a rate of 20° C./min and kept at 220±1° C. for 2 minutes in nitrogen stream. Thereafter, the sample was cooled at a rate of 20° C./min to 40±2° C. The sample was maintained at this temperature for 2 min, thereby permitting the sample to crystallize. Then, the sample was again fused at a temperature rise rate of 20° C./min up to 220° C.±1. The melting scan was recorded. A thermogram was obtained. The melting temperatures and crystallization temperatures were read.
Melt Flow Rate: Determined according to the method ISO 1133 (230° C., 5 kg).
Xylene-soluble fraction (XS) at 25° C.
Xylene Solubles at 25° C. were determined according to ISO 16152:2005; with solution volume of 250 ml, precipitation at 25° C. for 20 minutes, including 10 minutes with the solution in agitation (magnetic stirrer), and drying at 70° C.

### Intrinsic Viscosity (I.V.)

The sample was dissolved in tetrahydronaphthalene at 135° C. and then poured into the capillary viscometer.

The viscometer tube (Ubbelohde type) was surrounded by a cylindrical glass jacket, which permitted temperature control with a circulating thermostatic liquid.

The downward passage of the meniscus was timed by a photoelectric device. The passage of the meniscus in front of the upper lamp started the counter, which had a quartz crystal oscillator. The counter stopped as the meniscus passed the lower lamp. The efflux time was registered and converted into a value of intrinsic viscosity.

### Haze (on 1 mm Plaque)

5±5 cm specimens were cut molded plaques of 1 mm thick. The haze value was measured using a Gardner photometric unit connected to a Hazemeter type UX-10 or an equivalent instrument having G.E. 1209 light source with filter “C”. Standard samples were used to calibrate the instrument. The plaques were produced according to the following method.

75±75±1 mm plaques were molded with a GBF Plastiniector G235190 Injection Molding Machine, 90 tons under the following processing conditions:
Screw rotation speed: 120 rpm
Back pressure: 10 bar
Melt temperature: 260° C.
Injection time: 5 sec
Switch to hold pressure: 50 bar
First stage hold pressure: 30 bar
Second stage pressure: 20 bar
Hold pressure profile: First stage 5 sec
Second stage 10 sec
Cooling time: 20 sec
Mold water temperature: 40° C.

### Ethylene Content in the Copolymers

¹³C NMR spectra were acquired on a Bruker AV-600 spectrometer equipped with cryoprobe, operating at 160.91 MHz in the Fourier transform mode at 120° C.

The peak of the Sßß carbon (nomenclature according to “Monomer Sequence Distribution in Ethylene-Propylene Rubber Measured by ¹³C NMR. 3. Use of Reaction Probability Mode” C. J. Carman, R. A. Harrington and C. E. Wilkes, Macromolecules, 1977, 10, 536) was used as an internal standard at 29.9 ppm. The samples were dissolved in 1,1,2,2-tetrachloroethane-d2 at 120° C. with an 8% wt/v concentration. Each spectrum was acquired with a 90° pulse, and 15 seconds of delay between pulses and CPD, thereby removing ¹H-¹³C coupling. 512 transients were stored in 32K data points using a spectral window of 9000 Hz.

The assignments of the spectra, the evaluation of triad distribution and the composition were made according to Kakugo (“Carbon-13 NMR determination of monomer sequence distribution in ethylene-propylene copolymers prepared with δ-titanium trichloride-diethyl-aluminum chloride” M. Kakugo, Y. Naito, K. Mizunuma and T. Miyatake, Macromolecules, 1982, 15, 1150) using the following equations:

$$\begin{matrix}PPP = 100 T ββ / S & PPE = 100 T βδ / S & EPE = 100 T δδ / S \\ PEP = 100 S ββ / S & PEE = 100 S βδ / S & EEE = 100 ( 0.25 S γδ + 0.5 S δδ ) / S\end{matrix}$$

$$S = T ββ + T β δ + T δ δ + S β β + S β δ + 0.25 S γδ + 0.5 S δδ$$

The molar percentage of ethylene content was evaluated using the following equation:

$$E \% mol = 100 * [ PEP + P E E + E E E ]$$

The weight percentage of ethylene content was evaluated using the following equation:

$$\begin{matrix}100 * E \% mol * MWE \\ E \% wt . = E \% mol * MWE + P \% mol * MWP\end{matrix}$$

where P % mol is the molar percentage of propylene content, while MWE and MWP are the molecular weights of ethylene and propylene, respectively.

The product of reactivity ratio r1r2 was calculated according to Carman (C. J. Carman, R. A. Harrington and C. E. Wilkes, Macromolecules, 1977; 10, 536) as:

$${r}_{1} {r}_{2} = 1 + ( \frac{E E E + P E E}{P E P} + 1 ) - ( \frac{P}{E} + 1 ) {( \frac{E E E + P E E}{P E P} + 1 )}^{0.5}$$

The tacticity of propylene sequences was calculated as mm content from the ratio of the PPP mmT_{ββ} (28.90-29.65 ppm) and the whole T_{ββ} (29.80-28.37 ppm).

Impact test: ISO 180

Preparation of injection molded specimens: test specimens 80×10×4 mm were obtained according to the method ISO 1873-2:2007.

### Flexural Modulus

Measured according to ASTM D 790 on injection molded specimens.

Charpy Impact test at 23° C.: measured according to ISO 179-1:2010 on injection molded specimens.

### Specific Surface Area B.E.T.

Measured according to ISO 9277:2010.

### Particle Size Distribution

Measured with SediGraph 5100 particle size analysis system.

### Example 1

Catalyst system

The Ziegler-Natta catalyst was prepared as described for Example 5, lines 48-55 of

European Patent No. EP728769. Triethylaluminium (TEAL) was used as co-catalyst with dicyclopentyldimethoxysilane (DCPMS) as external donor, with the weight ratios indicated in Table 1.

### Prepolymerization Treatment

The solid catalyst component was subjected to prepolymerization by suspending the solid catalyst component in liquid propylene at 20° C. for about 5 minutes before introducing the solid catalyst component into the first polymerization reactor.

Polymerization

The polymerization run was conducted in continuous mode in a series of three reactors equipped with devices to transfer the product from each reactor to the subsequent reactor. The first two reactors were liquid phase reactors, and the third was a fluidized-bed, gas phase reactor. Component (A) was prepared in the first and second reactors. Component (B) was prepared in the third reactor.

Hydrogen was used as a molecular weight regulator.

The gas phase (propylene, ethylene and hydrogen) was continuously analyzed via gas-chromatography.

At the end of the run, the powder was discharged and dried under a nitrogen flow.

The main polymerization conditions are reported in Table 1.

TABLE 1

| | | ex1 | ex2 |
|---|---|---|---|
| TEAL/solid catalyst component | | 9.2 | 9.3 |
| weight ratio | | | |
| TEAL/DCPMS weight ratio | | 3 | 4 |
| Liquid phase reactors | | | |
| Polymerization temperature | ° C. | 67 | 67 |
| Pressure | Bar-g | 39 | 39 |
| Residence time | minutes | 51 | 53 |
| H2 feed | molppm | 401 | 420 |
| C2/(C2 + C3) | Mol ratio | 0.049 | 0.050 |
| Polymerization temperature | ° C. | 80 | 80 |
| Pressure | Barg | 18 | 18 |
| Residence time | min | 49 | 52 |
| C2/(C2 + C3) | Mol ratio | 0.052 | 0.062 |
| H2/C2 | Mol ratio | 0.083 | 0.082 |

C2 = ethylene;
C3 = propylene;
H2 = hydrogen

Table 2 reports the features of the compositions of examples 1-3 and comparative example 4.

TABLE 2

| Example | | Ex1 | Ex3 |
|---|---|---|---|
| Component A) | | | |
| Ethylene content | wt % | 4.0 | 4.3 |
| MFR | g/10′ | 1.5 | 1.6 |
| Xylene soluble at 25° C. | wt % | 6.0 | 6.4 |
| Melting temperature | ° C. | 139 | 137.5 |
| Component B) | | | |
| split | wt % | 25 | 22 |
| Ethylene content in component b) | wt % | 5.2 | 6.1 |
| Property of the composition | | | |
| Xylene soluble at 25° C. | wt % | 7.2 | 9.0 |
| MFR | g/10′ | 1.31 | 2.23 |
| XSIV (intrinsic viscosity of XS) | dl/g | 1.36 | 1.25 |
| Ethylene content on the xylene soluble fraction | Wt % | 20.2 | 17.9 |
| Ethylene content | wt % | 4.3 | 4.7 |

Components A and B were blended with talc (component C), having a particle size distribution between 0.5 and 5 μm and a surface area (B.E.T.) of 18 m²/g. A comparative example used a commercial talc HM05, having a particle size distribution between 0.5 and 5 μ and a surface area (B.E.T.) of 13 m²/g.
The results of the characterization of the compositions are reported on Table 3.

TABLE 3

| | | | Ex 1-1 | comp. Ex 1-2 |
|---|---|---|---|---|
| | | Ex 1-1 | 1000 ppm | 1000 ppm |
| | | no talc | talc | Talc HM05 |
| Melt Flow Rate | g/10 min | 1.31 | 1.64 | 1.6 |
| Haze | % | 23.8 | 25.6 | 26.4 |
| Haze after | % | 36.2 | 32.7 | 34.6 |
| sterilization | | | | |
| Δ haze | | 12.4 | 7.1 | 8.2 |
| Charpy 23° | KJ/M² | 15.9 | 36 | 28.5 |
| Flexural modulus | MPa | 690 | 814 | 800 |
| Tm | deg_C | 138.1 | 139 | 139.8 |
| Tc | deg_C | 95.2 | 100 | 99.9 |
| | | | Ex 2-1 | comp. Ex 2-2 |
| | | Ex 2-1 | 1000 ppm | 1000 ppm |
| | | no talc | talc | Talc HM05 |
| Melt Flow Rate | g/10 min | 2.23 | 1.89 | 2.22 |
| Haze | % | 23.5 | 25.7 | 27 |
| Haze after | % | 37.7 | 33.4 | 35.9 |
| sterilization | | | | |
| Δ haze | | 14.2 | 7.7 | 8.9 |
| Charpy 23° C. | KJ/M2 | 10.4 | 26.8 | 21.3 |
| Flexural modulus | MPa | 630 | 740 | 730 |
| Tm | deg_C | 136.6 | 138 | 137.8 |
| Tc | deg_C | 94.0 | 98.8 | 98.7 |

From table 3 results that the haze of the composition according to the invention after the sterilization results to be the lower while this is not before the sterilization. Therefore sterilized composition according to the disclosure has the lower haze.

What is claimed is:

1. A polyolefin composition comprising:
A) from 72 wt % to 90 wt %; of a copolymer of propylene with ethylene, having:
i) a content of ethylene derived units, measured by NMR, between 3.3 wt % and 6.0 wt %, based upon the total weight of the copolymer (A);
(ii) a melting temperature, measured by DSC, ranging from 132° C. to 143° C.;
(iii) a melt flow rate (230° C./2.16 kg., ISO 1133) ranging from 1.1 g/10 min to 3.5 g/10 min; and
(iv) xylene solubles at 25° C. ranging from 4.0 wt % to 10.0 wt %, based upon the total weight of the copolymer (A);
B) from 9 wt % to 28 wt %; of a propylene ethylene copolymer, having
i) a content of ethylene derived units, measured by NMR, ranging from 3.6 wt % to 7.5 wt %, based upon the total weight of the copolymer (B); and
ii) a melt flow rate (230° C./2.16 kg., ISO 1133) ranging from 0.6 g/10 min to 10 g/10 min;
wherein the polyolefin composition, having:
i) a content of ethylene derived units, measured by NMR, between 3.5 wt % and 5.5 wt %, based upon the total weight of the polyolefin composition;
ii) a content of ethylene derived units, measured by NMR, in the fraction soluble in xylene at 25° between 15.2 wt % and 23.2 wt %, based upon the total weight of soluble fraction;
iii) a melt flow rate (ISO 1133 (230° C., 2.16 kg)) ranging from 1.0 g/10 min to 4.0 g/10 min;
iv) xylene solubles at 25° C. ranging from 5.1 wt % to 12.0 wt %, based upon the total weight of the polyolefin composition;
v) an intrinsic viscosity, measured in tetrahydronaphthalene at 135° C., of the fraction soluble in xylene at 25° C. ranging from 0.6 dl/g to 2.5 dl/g; and
vi) the difference between the ethylene derived units content of component B and the ethylene derived units content of component A (C₂B-C₂A) ranging from 0.3 to 5.0 wt %;
the sum of the amounts A+B being 100; and
C) from 10000 ppm to 100 ppm of talc, having
i) a particle size distribution, measured with SediGraph 5100 particle size analysis system, between 0.5 and 5 μm; and
ii) a specific surface area B.E.T. (ISO 9277:2010) higher than 15 m²/g; wherein ppm being calculated on the sum of the amounts of A+B.

2. The polyolefin composition according to claim 1, wherein the content of ethylene derived units in component A) ranges between 3.5 wt % and 5.5 wt %.

3. The polyolefin composition according to claim 1, wherein, in component A), the melt flow rate (230° C./2.16 kg., ISO 1133) ranges from 1.2 g/10 min to 2.5 g/10 min.

4. The polyolefin composition according to claim 1, wherein, in component A), the xylene solubles at 25° C. ranges from 4.5 wt % to 9.0 wt %.

5. The polyolefin composition according to claim 1, wherein, in component B), the ethylene derived units content ranges from 3.8 wt % to 7.0 wt %.

6. The polyolefin composition according to claim 1, wherein the polyolefin composition has the content of ethylene derived units, measured by NMR, between 3.8 wt % and 5.3 wt %.

7. The polyolefin composition according to claim 1, wherein the polyolefin composition has the content of ethylene derived units, measured by NMR, in the fraction soluble in xylene at 25° between 16.3 wt % and 22.2 wt %.

8. The polyolefin composition according to claim 1, wherein the polyolefin composition has the melt flow rate (ISO 1133 (230° C., 2.16 kg) ranging from 1.1 g/10 min to 2.9 g/10 min.

9. The polyolefin composition according to claim 1, wherein the polyolefin composition has the xylene solubles at 25° C. ranging from 5.5 wt % to 11.0 wt %.

10. The polyolefin composition according to claim 1, wherein the polyolefin composition has the intrinsic viscosity, measured in tetrahydronaphthalene at 135° C., of the fraction soluble in xylene at 25° C. ranging from 0.8 dl/g to 2.0 dl/g.

11. The polyolefin composition according to claim 1, wherein, in component C), the specific surface area B.E.T. (ISO 9277:2010) ranges from 15 m²/g to 25 m²/g.

12. The polyolefin composition according to claim 1, wherein component A) ranges from 73 wt % to 88 wt % and component B) ranges from 13 wt % to 27 wt %.

13. The polyolefin composition according to claim 1, wherein the polyolefin composition has the content of ethylene derived units, measured by NMR, in the fraction soluble in xylene at 25° between 17.2 wt % and 21.3 wt %.

14. A blow molded article comprising the polyolefin composition according to claim 1.

15. The blow molded article of claim 14, wherein the article is a bottle.
